(19) United States
(12) Patent Application Publication
(10) Pub. No.: US 2011/0300842 A1
(43) Pub. Date: Dec. 8, 2011

(54) Method for Installing a Radio Base Station

(75) Inventor: Peter Bjorken, Solna (SE)

(73) Assignee: TELEFONAKTIEBOLAGET LM ERICSSON (PUBL), Stockholm (SE)

(21) Appl. No.: 12/673,094

(22) PCT Filed: Aug. 14, 2007
(86) PCT No.: PCT/SE07/50549

§ 371 Date: Feb. 11, 2010

(51) Int. Cl. H04W 16/00

(52) U.S. Cl. 455/418

(57) ABSTRACT

The present invention relates to a method for installing an end user controllable radio base station in a wireless communications network. The radio base station is adapted to provide access for the end user of wireless user equipment in the wireless communications network. The radio base station further comprises a display and a power level adjusting equipment. The method is characterized by a first step of connecting the radio base station to the wireless communications network. A second step is to activate a self configuration procedure of the radio base station. As a third step the display on the radio base station further displays instructions to the end user as part of the installation procedure. These instructions comprise a request for wireless user equipment activity. The activity of the wireless equipment is monitored, and the power level is adjusted, if needed, as a following step for completing the installation.

### TECHNICAL FIELD

The present invention relates to a method for setting up a small area radio base station, Femto RBS, in a wireless communications network. More particularly, the present invention relates to a method for selecting a location and power level for the installation of a small area radio base station.

### BACKGROUND

Femto Radio Base Stations (Femto RBSs), also called small area/office Base Stations or Pico Base Stations, are being developed in order to provide GSM and/or WCDMA coverage for end-users in small coverage areas e.g. at home, office, restaurants etc. A Femto BTS is typically connected to a separate Base Station Controller (BSC) or Radio Network Controller (RNC) Femto BSC/RNC.

The Femto RBS is expected to be sold to end users and they can then freely select the location for the Femto RBS in e.g. an apartment. This end user installation procedure makes the base station more of a consumer product requiring some end user interaction.

Coverage is an important aspect of radio access networks. For a Femto RBS in e.g. an apartment the coverage depends on the location of the base station and output power. In a first release of the Femto RBS the output power is estimated to typically be fixed between 0-10 dBm. The fixed output power can be pre-configured in the Femto RBS or selected during an installation procedure wherein the Femto RBS performs a self configuration and setup procedure. This self configuration and setup procedure is controlled by a control node (BSC/RNC).

In patent application publication US2007097939, there are described methods and apparatuses for configuring a Femto RBS. A macro receiver of the Femto RBS is used to acquire detected coverage information of a radio access network (RAN). The detected coverage information is used to determine an operation parameter for use by the macro transceiver of the Femto RBS. In one embodiment, the detected coverage information is transmitted to a control node of the RAN. The control node (BSC/RNC) determines the operation parameter and communicates the operation parameter to the Femto RBS. The Femto RBS is configured accordingly using the operation parameter for further operation towards User Equipments (UEs) accessing the Femto RBS.

FIG. 1 is a block diagram illustrating a GSM/WCDMA network including Femto RBSs working as Home Access Points (HAPs). The wireless communications network 1 includes a core network node (CN) 2 connected to a Network Controller 3 (BSC/RNC), using standard interface. Alternatively, the network controller is divided in a Macro part 10 and a Femto part 11. The Macro part 10 controls Macro Radio Base Stations, Macro RBSs, and the Femto part 11 controls Femto RBSs, HAPs. The network controller controls all Radio Base Stations that are in its area. Other types of RBSs like Micro RBSs and Pico RBSs are also controlled by the network controller (not shown in figure). The network controller 3 is connected and controls one or more Macro RBSs 4 and one or more Femto RBSs 5. Interfaces between the Femto RBSs and the network controller are standard interfaces with extensions to carry additional information needed for a Femto RBS. In WCDMA the interface is called Iub+ interface and is transported using an IP network providing IP connectivity between a Femto RBS and the network controller. In some scenarios the interface could be a standard Iub interface. IP networks may consist of unprotected and uncontrollable IP connections, therefore security mechanisms between the network control node and the Femto RBSs are typically included. Communication between the network controller 3 and the Macro RBS 4 is typically IP based or IP/ATM based, and the interface is typically Iub (for WCDMA, Abis interface is used in GSM). The Macro RBS 4 is working as an access point for one or more wireless User Equipment 9 (UE) and/or one or more Femto RBSs 6 within a macro cell 7. The group of Femto RBSs (HAPs) 5 is working as access points for UEs within Femto cells 8. The network controller 3 may also communicate with a Femto RBS 6 via the Macro RBS 4. This way the Femto RBS 6 uses the Macro RBS 4 as an access point for wireless user equipments into the core network. The Macro RNC and the Femto RNC would exchange information concerning access points, if necessary. An OSS 12 usually performs management of access points, Macro RBSs. A HAP manager 13 is typically included and responsible for managing HAPs, however other types of nodes can be used for managing the HAPs. A HAP database 14 (HAP DB) is used to store information related to the Femto RBSs. A Security Gateway 15 might be connected between the network controller 3 and the Femto RBS group 5. The OSS, the HAP manager and the HAP DB can be stand alone nodes or parts of other nodes like the control node 3 or the CN 2. The OSS and the HAP manager might also be distributed programs in a network 1.

A Femto RBS is installed and managed by end users in a plug-and-play manner which creates special needs for such a system and giving operators restricted information and restricted access to Femto RBSs. Problems with existing solutions is when using fixed output power for Femto BTSs it is likely to cause problems in terms of insufficient coverage, too high energy consumption and unnecessary radio transmission. A fixed output power level for Femto BTSs will be too low in some situations (e.g. a large house) which will cause coverage holes and bad end-user experience. The power level can also be too high in other situations (e.g. a small apartment) and this causes unnecessary high energy consumption and transmission which in turn increases the Specific Absorption Rate (SAR) value and generated interference to other base stations. The SAR value indicates an amount of electromagnetic radiation generated from mobile communication terminals and absorbed by humans.

In addition the free selection of the Femto BTS in the house or apartment may not be suitable and cause both insufficient coverage and excessive output power in different parts of the home environment.

### SUMMARY

Thus, an object of the invention is to provide a solution to optimized location and coverage of Femto Radio Base Stations and a method for installing and selecting a suitable power level.

In an embodiment of the present invention a method is described during which an end user can assist in finding a suitable power level and an appropriate location for a Femto Radio Base Station.

Another embodiment of the present invention is to provide a method for installing an end user controllable radio base station in a wireless communications network. The radio base station is adapted to provide access for the end user of wireless user equipment in the wireless communications network. The radio base station further comprises a display and a power level adjusting equipment. The method is characterized by a first step of connecting the radio base station to the wireless communications network. A second step is to activate a self configuration procedure of the radio base station. As a third step the display on the radio base station further displays instructions to the end user as part of the installation procedure. These instructions comprise a request for wireless user equipment activity. The activity of the wireless equipment is monitored, and the power level is adjusted, if needed, as a following step as part of completing the installation.

In yet another embodiment of the present invention there is provided a radio base station (RBS) adapted to provide access to an end user of wireless user equipment (UE). The UE is within a requested coverage area of a wireless communications network. The radio base station comprises connection equipments that are used to connect the radio base station to the wireless communications network. Activation equipment is included in the radio base station for activating a self configuration procedure of the radio base station. Also, the radio base station comprises a display that is used to display instructions to the end user as part of an installation procedure. These instructions comprise a request for wireless user equipment activity. The radio base station further comprises a monitor that is used to monitor activity of the wireless user equipment. A power level adjusting equipment is used in the radio base station in order to adjust the power level, if needed, as to complete the installation.

### BRIEF DESCRIPTION OF THE DRAWINGS

FIG. 1 is a block diagram illustrating a wireless communications network including Femto RBSs used as access points for user equipments located in Femto cells.

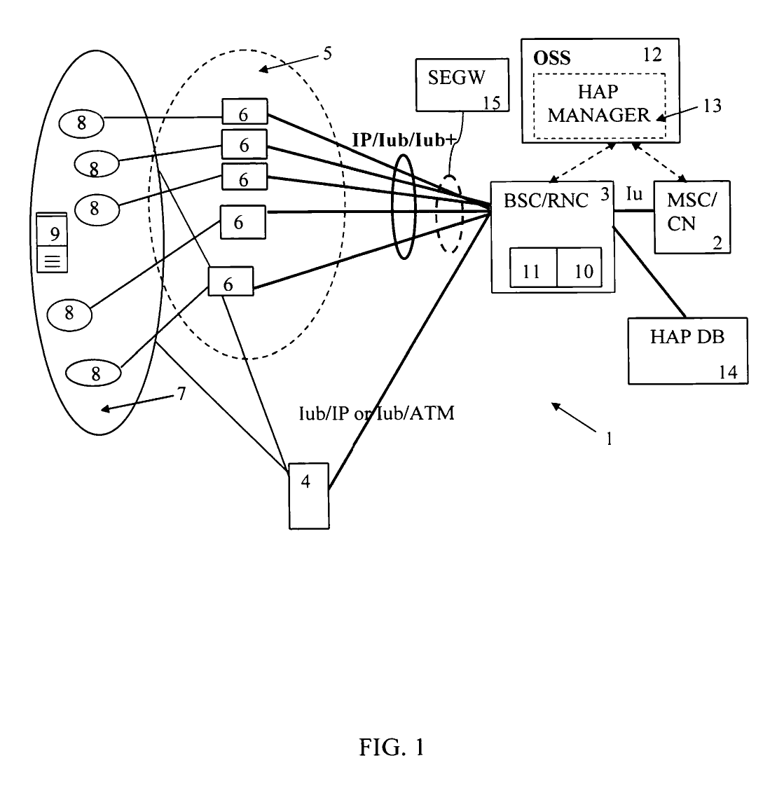

FIG. 2 is a signal diagram illustrating an embodiment of the present invention.

FIG. 3 illustrates a radio base station according to an embodiment of the present invention.

### DETAILED DESCRIPTION

It will be understood by those skilled in the art that various modifications and changes may be made to the present invention without departure from the scope thereof, which is defined by the appended claims.

A purpose of the present invention is to enable optimized selection of location and power of a Femto RBS in a home environment, office or small coverage area.

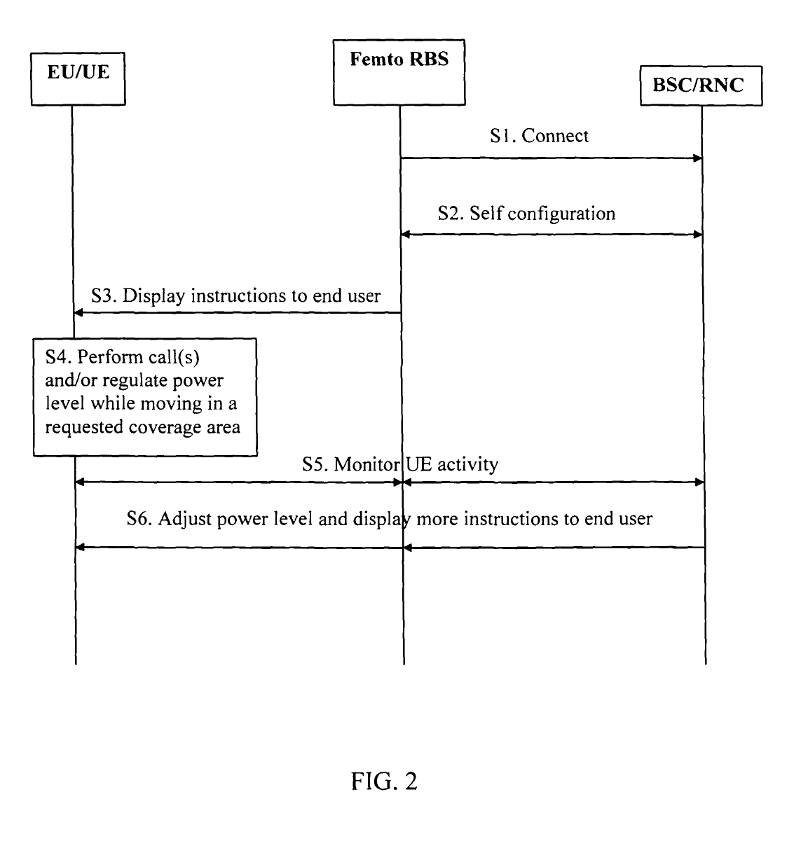

A solution is to provide a procedure during which an end user can assist in finding a suitable power level and an appropriate location for setting up a Femto RBS by means of a display and power level adjusting equipment on the Femto RBS. The power level adjusting equipment may be software in the RBS and/or a regulator reachable for the end user. An example method for finding the suitable power level and the appropriate location of the Femto RBS is described by FIG. 2.

As an example the invention details how an end user initiates an installation procedure by pressing a button on the Femto RBS. The procedure includes monitoring of packet switched (PS) or circuit switched (CS) calls and thereafter selecting an appropriate power level, automatically or manually executed power level regulation, or determining if a current location of the Femto RBS is appropriate. There is also the possibility of indicating a current coverage level on a display and how this coverage level could be improved by moving the Femto RBS to a new location within a home environment and following the instructions on the display. The instructions as for example: make one or more calls from the wireless user equipment while moving around in a requested coverage area; turn your laptop on and start downloading files while moving in a requested coverage area etc.

Mentioned above, FIG. 2 is a signal diagram illustrating an embodiment of the present invention. As a non limiting example a GSM network is used to illustrate the invention and a description is given of a simplified implementation of the present invention. According to this non limiting example a triggering node detects or activates a triggering event starting a self configuration procedure. Typically the triggering event is one of the following: a person connecting the Femto RBS to the wireless network or a person, i.e. end user, activating a self configuration procedure by the aid of activation equipment. The triggering node, the Femto RBS, informs a core network node (CN) (e.g. MSC, RNC, OSS, HLR, VLC, SGSN) that a self configuration procedure is initiated. These are the steps of the invention in more details:

1. The end user typically places the Femto RBS over an entry door at a house or connects the Femto RBS directly to an IP network. If the Femto RBS is not directly connected to the IP network then it might be connect through another access point. The end user can therefore freely choose the location of the Femto RBS and set up a wireless connection to for example a wireless router.
2. A self configuration is automatically or manually activated. This procedure may or may not involve the BSC/RNC and/or the OSS participating in the self configuration. At this point a Femto RBS is functional and can be used to make phone calls, establish data connections etc. The output power level can e.g. be selected based on pre-configuration in the Femto RBS or by command from the control node (BSC/RNC).
3. The end user initiates an installation procedure by for example pressing a display button or making a call. The display on the Femto RBS starts displaying instructions to the end user as part of the installation procedure. These instructions to the end user comprise recommendation (order) for performing one or more calls from the wireless user equipment while moving between different locations in an intended coverage area. The instructions may also include manual regulations of the power level, if needed. Typically the power level adjustments are performed by the RBS without any interference from any other node. As an alternative the display on the Femto RBS may instruct the end user to perform a single phone call and to walk around in a requested coverage area where the Femto RBS is intended to provide coverage. During the installation procedure the Femto RBS would typically use highest possible power level as a default level.
4. The end user performs one or multiple phone calls using a wireless user equipment (UE) at different locations in a requested coverage area (home environment) where the Femto RBS shall or is intended to provide services.
5. The Femto RBS monitors the radio quality during the phone call(s). This can be e.g. received signal level (RxLev) on Down Link (DL) and/or Up Link (UL) and/or received quality (RxQual) on DL and UL. The DL measurements are typically obtained from Measurement Reports sent from the UE. Other types of measurements are also possible.
6. The Femto RBS concludes a most appropriate power level based on monitored radio quality during the phone calls. This would typically be a lowest possible power level while still providing full coverage. As an example, if a received signal level is 3 dB higher than required to provide full coverage then a concluded power level can be 3 dB lower than a power level used during the installation procedure. The concluded power level is then set by the Femto RBS. The end user might regulate the power level himself. Additionally, the power level may or may not be sufficient to provide full coverage at the home environment with the current location of the Femto RBS. Therefore, a new location for set up is recommended on the display, e.g. a recommendation to move the Femto RBS closer to a position where a specific phone call was made during the installation. The installation procedure is thereafter repeated at the new location.

In another preferred embodiment the Femto BTS determines the expected service level (e.g. % of coverage) with a current location of the Femto RBS. This is done as mentioned above, e.g. by monitoring received signal level (RxLev) on DL and UL and received quality (RxQual) on DL and UL. The expected service level can then be displayed to an end user and there can also be an indication to move the Femto RBS closer to a certain position identified by a specific phone call (e.g. “Femto RBS cannot provide full coverage at current location, please move closer to where phone call #3 was made.”). This step can also be performed even if the maximum power level is sufficient to provide full coverage with the current location of the Femto RBS and the benefit would then be the possibility to use lower power in the home environment.

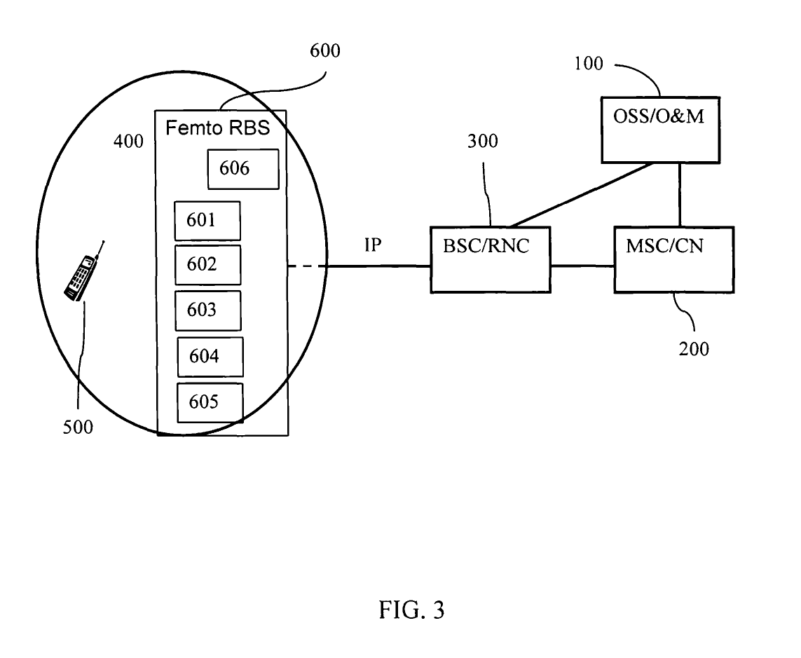

FIG. 3 illustrates a Radio Base Station 600 adapted to provide access to an end user of wireless user equipment 500. The equipment 500 is within a requested coverage area 400 of a wireless communications network 1. The radio base station is preferably a Femto radio base station, Femto RBS, intended to give coverage for end users using wireless user equipment 500 over a small area like for example homes, offices, shopping areas, school buildings etc. The radio base station 600 comprises connection equipments 601 used to connect the radio base station to the wireless communications network 1. The connection equipments 601 connect the RBS 600 to the wireless communication network 1 by wire directly or wirelessly by the aid of another wireless access point in the wireless communications network (dashed line in the figure). Activation equipment 602 is included to activate a self configuration procedure of the RBS 600. The activation equipment 602 is automatically activated when the RBS is connected to the network 1 or manually e.g. a person turning on the RBS 600. As part of the self configuration procedure the RBS 600 might communicate with a network control node (300, 200, and 100) in order to select a reference power level as default. The RBS 600 further comprises a display 603 for displaying instructions to the end user, as part of an installation procedure. The displayed instructions comprise a request for wireless user equipment activity, e.g. instructions to make one or more calls while moving between different locations in the requested coverage area. Alternatively the instructions comprise an additional step of an order to the end user to move the radio base station to a new location in the requested coverage area. The RBS 600 further comprises a monitor 604 in use to monitor activity of the wireless user equipment 500. The instructions displayed on the display partially are based on measured and monitored downlink and uplink signals between the radio base station and the wireless user equipment. Other radio quality measurements might also be performed like interference measurements from macro RBS and interference from other Femto RBS in an overlapping area. The RBS 600 comprises also a power level adjusting equipment 605 used to adjust the power level, if needed, to complete the installation. New instructions and new measurements might be needed even after adjusting the power level. Also the end user might have a requested power level which can influence the location of the radio base station. Alternatively, the end user can move the radio base station to influence the power level.

In yet an embodiment of the present invention the RBS 600 might further comprise a regulator 606 making it possible for the end user to manually regulate the power level. The regulation can be based on displayed instructions and/or according to a preferred power level giving a requested radio quality in a requested coverage area. That is an acceptable power level, for the end user, in a requested coverage area e.g. his home or the main part of home, building etc. The end user might have own restriction for a SAR value and therefore is comfortable with low bandwidth or less coverage in order to decrease the power level.

In yet another embodiment of the present invention the method can be part of a program product distributed between control nodes 300 and core network nodes (100, 200) of a wireless communications network 1. The method can also be software stored on a disc downloaded to the RBS 600 as part of the self configuration procedure. The disc is then used by for example a wired or wireless station in the coverage area to execute the method of claims 1-9. The RBS can as well have an entry for a for example USB port wherein software can be initiated.

The invention is not limited to the examples of embodiments described above and shown in the drawings, but may be varied freely within the scope of the appended claims. For example, as has also been pointed out elsewhere in this text, the invention may be applied in a variety of systems which utilize the principle of information reporting between two nodes in the system.

1-18. (canceled)

19. A method of automatic configuration and setup performed by an end user controllable radio base station, said radio base station adapted to provide access for an end user of a wireless user equipment to a wireless communications network, the method comprising said base station:
establishing a connection with the wireless communications network; and
activating a self configuration and setup procedure, including:
prompting the end user to use the wireless user equipment with the radio base station;
monitoring activity of the wireless user equipment; and
adjusting a power level of the radio base station as needed, responsive to said monitoring.

20. The method of claim 19, wherein the radio base station is a Femto radio base station (Femto RBS) that is configured to provide wireless service coverage over a small area.

21. The method of claim 19, wherein the self configuration and setup procedure includes selecting a reference power level as a default power level of the radio base station.

22. The method of claim 19, wherein said step of establishing the connection with the wireless communications network comprises establishing communication with the wireless communications network via a wired or wireless connection to an IP network.

23. The method of claim 19, wherein said step of prompting the end user to use the wireless user equipment with the radio base station comprises displaying instructions on a radio base station display that instruct the end user to perform one or more calls from the wireless user equipment from different locations in a requested coverage area of the radio base station.

24. The method of claim 19, further comprising, in dependence on monitoring activity of the end user equipment while being operated in the requested coverage area, indicating to the end user that the radio base station should be moved to a new location within the requested coverage area.

25. The method of claim 19, wherein said step of monitoring comprises measuring and monitoring downlink and uplink signals between the radio base station and the wireless user equipment, and wherein the self configuration and setup procedure includes displaying instructions to the end user based on said monitoring.

26. The method of claim 25, wherein said step of displaying instructions to the end user comprises selectively instructing the end user to move the radio base station to another location within the requested coverage area, in dependence on said measuring and monitoring.

27. The method of claim 19, further comprising adjusting the power level of the base station responsive to input by the end user.

28. The method of claim 19, wherein said step of prompting comprises displaying instructions to the end user to make calls from the wireless user equipment at different locations within a requested coverage area of the radio base station, said step of monitoring comprises measuring uplink or downlink signals between the wireless user equipment and the radio base station for the calls made from the different locations, and further indicating to the end user when full coverage cannot be provided by the radio base station for one or more the calls.

29. A radio base station adapted to provide access to an end user of wireless user equipment to a wireless communications network, said radio base station comprising:
connection equipment configured for connecting the radio base station to the wireless communications network;
activation equipment for activating a self configuration and setup procedure of the radio base station by which the radio base station is configured to:
prompt the end user to use the wireless user equipment with the radio base station;
monitor activity of the wireless user equipment; and
adjust the power level of the radio base station as needed, responsive to said monitoring.

30. The radio base station of claim 29, wherein the radio base station is a Femto radio base station (Femto RBS) that is configured to provide wireless service coverage over a small area.

31. The radio base station of claim 29, wherein the activation equipment is configured to communicate with a network control node during the self configuration and setup procedure, for selecting a reference power level as default power level of the radio base station.

32. The radio base station of claim 29, wherein the connection equipment is configured to connect the radio base station to the wireless communication network via a wired or wireless connection to an IP network.

33. The radio base station of claim 29, wherein the radio base station includes a display and wherein the activation equipment prompts the end user by displaying instructions on the display that instruct the end user to perform one or more phone calls from the wireless user equipment from different locations in a requested coverage area of the radio base station.

34. The radio base station of claim 29, wherein, in dependence on monitoring activity of the end user equipment while being operated in the requested coverage area, the radio base station is configured, as part of performing the self configuration and setup procedure, to indicate to the end user that the radio base station should be moved to a new location within the requested coverage area.

35. The radio base station of claim 29, wherein the radio base station monitors the activity of the wireless user equipment by measuring and monitoring downlink and uplink signals between the radio base station and the wireless user equipment, and wherein the self configuration and setup procedure includes displaying instructions to the end user based on said monitoring, and wherein the radio base station includes a display for displaying said instructions.

36. The radio base station of claim 35, wherein the radio base station is configured to selectively instruct the end user to move the radio base station to another location within the requested coverage area, in dependence on said measuring and monitoring.

37. The radio base station of claim 29, wherein the radio base station further comprises a regulator for adjusting the power level and wherein the radio base station is configured to adjust the power level responsive to user input.

38. The radio base station of claim 29, wherein the radio base station is configured to prompt the user by displaying instructions to the end user to make calls from the wireless user equipment at different locations within a requested coverage area of the radio base station, and to monitor the activity by measuring uplink or downlink signals between the wireless user equipment and the radio base station for the calls made from the different locations, and is further configured to indicate to the end user when full coverage cannot be provided by the radio base station for one or more the calls.

39. A method of self configuration and setup performed by a radio base station that is configured for use by an end user in providing radio coverage over a small area, said method comprising:
connecting to a wireless communication network; and
activating a self configuration and setup procedure which includes:
prompting the end user to make calls through the radio base station from different locations within a intended coverage area of the radio base station;
performing signal measurements for said calls; and
based on said signal measurements, performing at least one of: adjusting a power level of the radio base station, or instructing the end user to move the radio base station to another location within the intended coverage area.
